(19) United States
(12) Patent Application Publication
(10) Pub. No.: US 2024/0374454 A1
(43) Pub. Date: Nov. 14, 2024

(54) RECONFIGURABLE ROTARY SERIES ELASTIC ACTUATOR

(71) Applicant: NATIONAL UNIVERSITY OF SINGAPORE, Singapore (SG)

(72) Inventors: Yuepeng QIAN, Singapore (SG); Haoyong YU, Singapore (SG)

(21) Appl. No.: 18/287,322

(22) PCT Filed: Jun. 10, 2022
(86) PCT No.: PCT/SG2022/050402

§ 371 Date: Oct. 18, 2023

(30) Foreign Application Priority Data
Jun. 30, 2021 (SG) 10202107200X

(51) Int. Cl. B25J 9/12; A61H 3/00; B25J 19/02; F16H 19/08

(52) U.S. Cl. CPC B25J 9/126; A61H 3/00; B25J 19/02; F16H 19/08

(57) ABSTRACT

Disclosed is a reconfigurable rotary series elastic element (RSEE) comprising: an inner tension spring mount: an outer tension spring mount; and a plurality of tension springs connected between the inner tension spring mount and outer 5 tension spring mount. A position at which each spring connects to one or both of the inner tension spring mount and outer tension spring mount: can be changed to adjust a relationship between an output torque and deflection angle of the RSEE; and is configured such that, during relative rotation of the inner tension spring mount and outer tension spring mount, an amount of tension in 10 at least one said tension spring differs from an amount of tension in at least one other said tension spring.

### TECHNICAL FIELD

The present invention relates, in general terms, to a reconfigurable rotary series elastic element and a series elastic actuator comprising such a RSEE.

### BACKGROUND

Recently, various assistive robots have been developed to physically assist disabled people or to augment human power. These robotic devices, such as powered exoskeletons for walking assistance, significantly improve the mobility of people with disabilities and the quality of their lives. In such applications, assistive robots necessarily have direct physical interaction with the human using them.

To improve the performance and safety of physical human-robot interaction (pHRI), the design of the actuator and the corresponding controller are of great importance. The use of compliance, including active compliance generated by control and passive physical compliance, has been considered essential for assistive robots and vital to improve dynamical adaptability and robustness with the environment, and to achieve a safe pHRI. Although there have been a number of new developments in the design and control of different compliant actuators, it remains challenging to obtain satisfactory pHRI performance in practical applications.

Series elastic actuator (SEA) is one such compliant actuator, in which the physical elastic element is intentionally introduced in series between the stiff actuator and the external load. Different SEAs have been developed for assistive robots to capitalize on the advantages of the SEA, including lower output impedance, good back-driveability, shock tolerance, energy efficiency, smooth and accurate force transmission, and safety for pHRI. However, SEAs typically use springs with fixed stiffness as the elastic element in force transmission, which is the fundamental limitation of conventional SEAs as the performance of SEAs is highly dependent on the spring constant. On the one hand, a soft spring produces high force control fidelity, low output impedance, and reduces stiction, but also limits the force range and the force bandwidth. On the other hand, a stiff spring increases the force bandwidth, but reduces force fidelity. To achieve the desired force output and sufficient force bandwidth, most existing SEAs use springs with high stiffness, leading to compromised force control performance, low intrinsic compliance and back-drivability.

To overcome the fundamental limitation of conventional SEAs, a number of novel compliant actuators have been proposed. Variable stiffness actuators (VSAs) are one of the most investigated examples. VSAs are able to adjust their stiffness based on various working principles. Among these working principles, tuning the elastic element by a secondary motor and a complicated stiffness adjustment mechanism is the most common approach to achieve stiffness variation. As a consequence, these actuators are generally complicated and heavy, which increases the complexity of the control and makes deployment in assistive robots difficult, especially in wearable assistive robots.

Apart from VSAs, the introduction of nonlinear stiffness in SEAs also provides a promising solution to the limitation of conventional SEAs. But existing designs still show limitations in achieving nonlinear stiffness and improving adaptability to different applications in assistive robots. In some cases, nonlinear stiffness behaviours were achieved with specially designed cam shape, leading to a lack of adaptability to different applications. Some novel and reconfigurable designs that are able to generate nonlinear and adjustable stiffness behaviours are available. But the reconfigurability and adjustable stiffness of such devices are achieved using various complicated winding methods at the pulley blocks, resulting in limited model accuracy because of friction, making it difficult to achieve satisfactory control performance in the pHRI.

It would be desirable to provide new device designs for overcoming the aforementioned limitations of existing nonlinear SEAs for improving the performance of pHRI and the adaptability to different applications, or at least to provide a useful alternative.

### SUMMARY

Described herein are compliant actuator designs and, more particularly, reconfigurable rotary series elastic actuators (SEAs) with nonlinear stiffness for assistive robots. The described devices feature nonlinear stiffness and adjustable stiffness profiles generated by a novel and reconfigurable rotary series elastic element (RSEE) with ordinary tension springs. The non-linear stiffness can overcome limitations of conventional SEAs caused by constant stiffness and improve the performance of human-robot interaction. Different stiffness profiles can be yielded by changing different configurations of the reconfigurable RSEE, enabling this modular actuator to be applied to different assistive robots and tasks.

Disclosed is a reconfigurable rotary series elastic element (RSEE) comprising:
an inner tension spring mount;
an outer tension spring mount; and
a plurality of tension springs connected between the inner tension spring mount and outer tension spring mount, wherein a position at which each spring connects to one or both of the inner tension spring mount and outer tension spring mount;
can be changed to adjust a relationship between an output torque and deflection angle of the RSEE; and
is configured such that, during relative rotation of the inner tension spring mount and outer tension spring mount, an amount of tension in at least one said tension spring differs from an amount of tension in at least one other said tension spring.

The inner tension spring mount may be an inner plate, and wherein the outer tension spring mount comprises two outer plates, the inner plate being disposed between the outer plates.

The outer tension spring mount may comprise a plurality of spaced hitching holes defining locations at which the tension springs can be selected to connect to the outer tension spring mount.

Each tension spring may connect to the outer tension spring mount by a connecting shaft. Each tension spring may define an angle between the inner tension spring mount and outer tension spring mount, and wherein the relationship can be adjusted by offsetting the angle of one or more of the tension springs. The relationship may be adjusted by changing a pretension length of one or more of the tension springs.

The relationship can be adjusted by changing adding or removing tension springs between the inner tension spring mount and outer tension spring mount.

The RSEE may further comprise two bearings disposed on opposite sides of the inner plate, between the inner plate and outer plates.

Also disclosed is a series elastic actuator (SEA) comprising:
a RSEE as described above; and
a driving assembly for driving one of the inner tension spring mount and outer tension spring mount.

The driving assembly may drive the inner tension spring mount.

The SEA may further comprise a housing for housing the RSEE.

The SEA may further comprise a first angle measurer for measuring changes in an angle of the inner tension spring mount, and a second angle measurer for measuring changes in an angle of the outer tension spring mount. The driving assembly may comprise a motor for providing driving force, an embedded gear reducer, an output shaft connected to the inner tension spring mount and the first angle measurer. The SEA may further comprise a shaft sleeve to fix a position of the output shaft along an axis of rotation of the inner tension spring mount.

Each angle measurer may be an encoder. Each encoder may be a rotary encoder.

Advantageously, the RSEE has nonlinear stiffness. Nonlinear stiffness can overcome limitations of conventional SEAs caused by constant stiffness. Such embodiments can also make use of ordinary tension springs rather than special torsion spring with nonlinear stiffness, which is low-cost and accurate.

Arrangements described herein provide a large deflection range and high torque resolution compared with existing torsion springs used in rotary series elastic actuators.

Advantageously, the design of the RSEE, is reconfigurable. As such, different stiffness profiles can be generated by changing the configuration of the reconfigurable RSEE. Moreover, stiffness profile is adjustable, enabling the actuator to be used (or multiple actuators in modular designs) for different assistive robots and tasks.

### BRIEF DESCRIPTION OF THE DRAWINGS

Embodiments of the present invention will now be described, by way of non-limiting example, with reference to the drawings in which:

FIG. 1 is a perspective view of a reconfigurable RSEE in a device, in accordance with the present disclosure;

FIG. 2 is an exploded perspective view of the reconfigurable RSEE actuator of FIG. 1;

FIG. 3 is a perspective view of a reconfigurable RSEE in accordance with the present disclosure;

FIG. 4 is an exploded perspective view of the reconfigurable RSEE of FIG. 3;

FIG. 5 is a schematic diagram of an example embodiment of an RSEE configured by varying the pretension length Δl of tension springs;

FIG. 6 shows the relation of output torque to deflection angle of the RSEE of FIG. 5;

FIG. 7 is a schematic diagram of an example embodiment of an RSEE configured by varying offset angle φ of tension springs;

FIG. 8 shows the relation of output torque to deflection angle of the RSEE of FIG. 7;

FIG. 9 is a schematic diagram of an example embodiment of an RSEE configured by varying offset angle φ of tension springs;

FIG. 10 shows the relation of output torque to deflection angle of the RSEE of FIG. 9;

FIG. 11 is a mechanical design and prototype of a RRSEAns according to present teachings, in which image (a) is the overall view of a computer aided design (CAD) model, image (b) is an exploded view of the CAD model, image (c) is a first configuration with variable spring pre-tension length (up to 6 spring pairs), image (d) is a second configuration with variable offset angle (up to 6 spring pairs), image (e) is 1/3 configuration with variable offset angle (up to 4 spring pairs), and image (f) is an RRSEAns prototype used for testing;

FIG. 12 is a schematic of a reconfigurable RSEE, in which image (a) shows a configuration with spring pre-tension and image (b) shows a configuration with an offset angle;

FIG. 13 shows, in image (a) shows simulation results of the effects of two adjustable variables on the output torque and stiffness of the RRSEAns, and image (b) shows model validation by experimental results:

FIG. 14 is a schematic linearised model of the RRSEAns in accordance with present teachings;

FIG. 15 illustrates an embodiment of a cascade PI controller; and

FIG. 16 shows the frequency responses of the RRSEAns with different levels of nonlinearity, in which image (a) shows open-loop response with low output torque, image (b) shows closed-loop response with low output torque, image (c) shows open-loop response with high output torque, and image (d) shows closed-loop response with high output torque.

### DETAILED DESCRIPTION

A reconfigurable rotary series elastic actuator with nonlinear stiffness (RRSEAns) is described for assistive robots. Nonlinear and adjustable stiffness profiles are generated by a novel reconfigurable rotary series elastic element (RSEE), which can help achieve a good balance among low output impedance, high fidelity of force control, large force bandwidth and output force range. Linear tension springs are used as the basic elastic element in the reconfigurable RSEE and the stiffness profile is able to be adjusted by changing the setting of the RSEE. Moreover, a kinematic model based on two different adjusting principles is established, which clearly reveals the influence of the adjustable parameters on stiffness characteristics and also provides guidance for design and stiffness adjustment.

In addition to the actuator design, the controller design is also important for achieving satisfactory performance and guaranteed safety of the pHRI. For the controller design, nonlinear stiffness usually makes it more difficult to achieve accurate and stable force control. As an easy-to-apply and robust controller, a cascade PID is chosen in some embodiments for force control of linear SEAs. With the cascade PID controller, effective and robust force control can be achieved because the velocity-loop bandwidth of the driven motor is much higher than the force-loop bandwidth of the SEA and motor dynamics are decoupled from the load side. Described below is a cascade PI controller designed for torque control of the proposed actuator with nonlinear stiffness. Based on the adjustable stiffness profiles, tests of human-robot interaction with highly nonlinear and linear stiffness are performed, clearly demonstrating the advantages of nonlinear stiffness in pHRI.

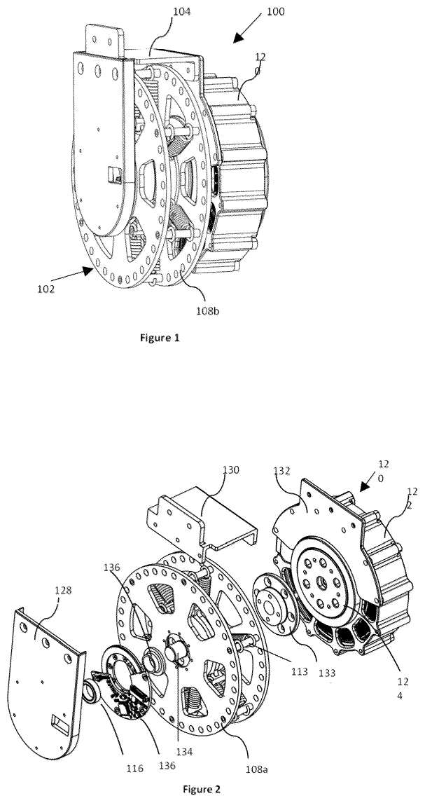

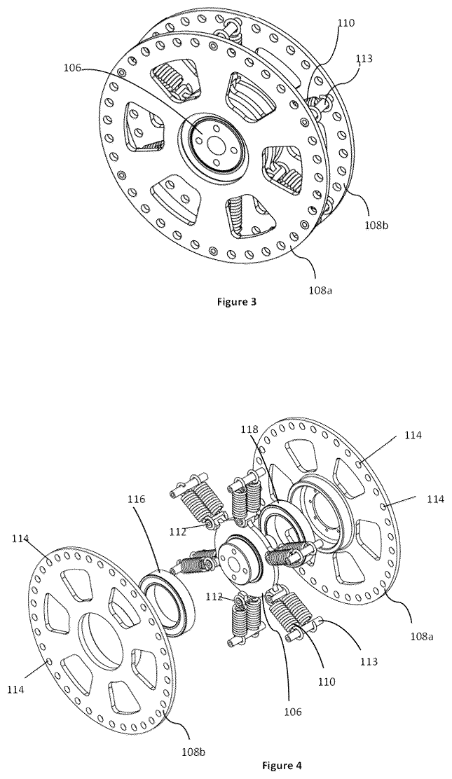

FIGS. 1 to 4 show such a device 100 incorporating a reconfigurable rotary series elastic element (RSEE) 102 that imparts nonlinear stiffness to the system, to facilitate use in assistive robots. In some embodiments, the device 100 with RSEE 102 is provided as a single unit. In other embodiments, the RSEE is provided on its own, for incorporation into another device.

The device 100 comprises a housing assembly 104. The housing assembly 104 holds the device 100 in position relative to a system for assisting movement of a human. The device is thus attached at a joint that provides relative movement between two members (e.g. knee for movement between the upper and lower leg, or elbow for movement between the forearm and upper arm). The housing may be attached to one member (e.g. upper arm) and the outer tension spring mounts (discussed below) may be attached to the other member (e.g. forearm).

For example, the device may be attached at a knee joint of a system comprising an upper leg member for fixing to the thigh of the human, and a lower leg member for fixing to the lower leg of the human. The device can then assist with controlled bending at the knee and in providing appropriate resistance to assist with controlled movement of the leg. Similar comments apply in respect of the device being positioned at another join on the human—e.g. elbow joint.

The RSEE 102 comprises an inner tension spring mount 106, an outer tension spring mount, presently embodied by plates 108a and 108b, and a plurality of tension springs 110. The tension springs 110 extend or connect between the inner tension spring mount 106 and outer tension spring mount (108a, 108b). The tension springs 110 may be any suitable spring but are, in general, envisaged to be ordinary (e.g. linear spring constant) springs.

As discussed with reference to FIGS. 5, 7 and 9, a position at which each spring 110 connects to one or both of the inner tension spring mount 106 and outer tension spring mount (108a, 108b) can be changed to adjust a relationship between an output torque and deflection angle of the RSEE 102. This enables the RSD 102 to be reconfigured, for example, to adjust the amount of pension required to rotate the inner spring mount 106 relative to the outer spring mount (108a, 108b). The positions at which springs 110 are connected to the spring mounts (106, 108a, 108b) is also configured such that, during relative rotation of the inner tension spring mount 106 and outer tension spring mount (108a, 108b), an amount of tension in at least one said tension spring 110 differs from an amount of tension in at least one other said tension spring 110. Thus the RSEE 102 has a nonlinear force response.

The inner tension spring mount 106 takes the form of an inner plate. Positions 112 at which the springs 110 attached to the inner plate 106 are evenly distributed around the periphery of the inner plate 106. In other embodiments, the position is 112 may be distributed unevenly around the periphery of the inner plate 106, or may be located at various radial distances from an axis of rotation of the inner tension spring mount.

The outer tension spring mount similarly comprises two outer plates 108a and 108b. The inner plate 106 is disposed between the outer plates (108a, 108b). In some embodiments, the outer tension spring mount may only comprise a single plate or other member located to one side of the inner tension spring mount. However, for stability against bending under laterally imposed loads (i.e. loads with a non-zero component parallel to an axis of rotation of the inner tension spring mount) it is desirable that the inner tension spring mount 106 located between members of the outer tension spring mount.

To facilitate relative rotation between the RSEE 102 and the housing 104, a bearing 126 is provided between the RSEE 102 and a plate 128 of the housing 104. Presently, the housing comprises two plates 128, 132 between which the RSEE 102 is sandwiched, the plates 128, 132 being connected by a top platen 130. A driving assembly 120 is connected to one of the plates 132 in fixed relation. The inner tension spring mount is mounted to, or comprises, a shaft 134. To maintain accurate alignment of the shaft with the housing, the shaft 134 rotates within a shaft sleeve 136.

The outer tension spring mount comprises a plurality of positions, presently embodied by hitching holes 114, to which the tension springs 110 can be connected. The hitching holes 114 may be distributed evenly about the periphery of the outer tension spring mounted, as shown alternatively, the hitching holes 114 may be unevenly distributed about the periphery of the outer tension spring mount, or may be positioned and variously different radial distances from axis of rotation of the outer tension spring mount. While the tension springs 110 may be directly connected to the outer tension spring mount, the present tension springs 110 are connected to shafts 113 that are connected at opposite ends to respective ones of the plates 108a, 108b.

The inner spring mount (plate 106) rotate relative to the outer spring mount (plates 108a, 108b). To facilitate that rotation the inner spring mount is connected to the two outer plates 108a and 108b by a two bearings 116 on a 118. The two bearings 116, 118 are disposed on opposite sides of the inner plate 106, between the inner plate 106 and outer plates 108a, 108b. The inner plate 106 can thus rotate freely with respect to the outer plates 108a and 108b. Tension springs 110 are disposed in the space between the inner plate 106 and two outer plates 108a and 108b. Tension springs 110 are connected to the inner plate 106 via hitching points 112 of the inner plate 106, and connected to the two outer plates 108a and 108b via the connecting shafts 113 that are disposed in hitching holes 114 of the two outer plates 108a and 108b.

With reference to FIGS. 2 and 4, the device 100 includes a driving assembly 120, for driving one of the inner tension spring mount in the outer tension spring mount. The present driving assembly 120 drives the inner tension spring mount.

Driving assembly 120 comprises a motor 122 that drives an output shaft 124. To adjust the force applied by the motor 122, the driving assembly may also include an embedded gear reducer.

The output shaft 124 is connected to the inner plate 106 of the reconfigurable RSEE 102 via a connector 126. The connector 126 ensures that force from the output shaft 124 is evenly distributed around the plate or plates, presently inner plate 106, rotation of which is being driven by the driving assembly 120.

To control an amount of relative rotation between the inner tension spring mounted and outer tension spring mounted, thereby controlling an amount of relative rotation between two members of, for example, an exoskeleton for assistive movement, one or more angle measurers are provided. Each angle measurer measures an angle between either the inner tension spring mount and outer tension spring mount, or between the one of the spring mounts and the housing 104. Presently, there are two angle measurers. A first angle measurer 133 is used to measure changes in the angle of the output shaft, that is, the changes in the angle of the inner plate 106. The first angle measurer may be a rotary encoder that operates in a known manner, being fixed to one of the inner tension spring mounted and outer tension spring mounted to measure rotational changes of the other of the inner tension spring mount and outer tension spring mount. A second angle measurer 136 measures changes in the angle of the outer plates 108a and 108b relative to the shaft 124 or the housing assembly 104—e.g. measures angular rotation of the outer plates or inner plate relate to the housing, motor or some other point. The angle measurers may be any appropriate device, such as an encoder or rotary encoder. The different readings of the angle measurers 133, 136 can be used to deduce the deflection angle of the RSEE 102. In other words, the angle difference between the angles of the inner plate 106 and the outer plates 108a and 108b is the deflection angle of the reconfigurable RSEE 3. The output torque can be precisely calculated based on a kinematic model of the reconfigurable RSEE 3 and Hooke's Law.

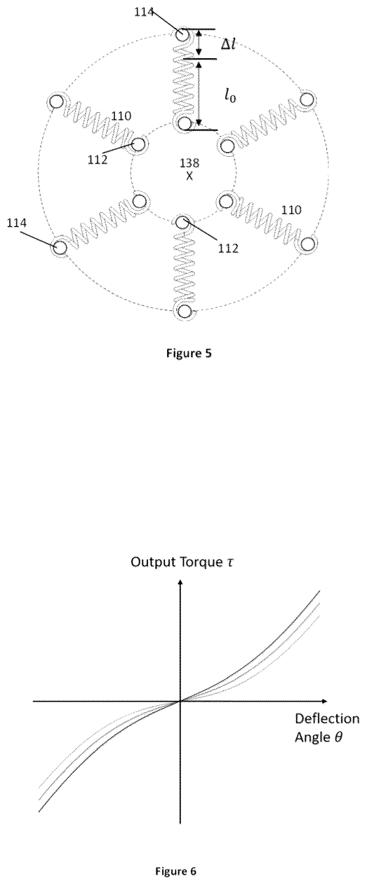

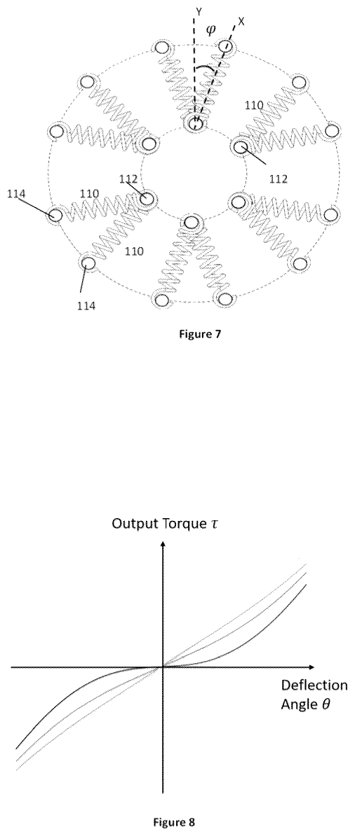

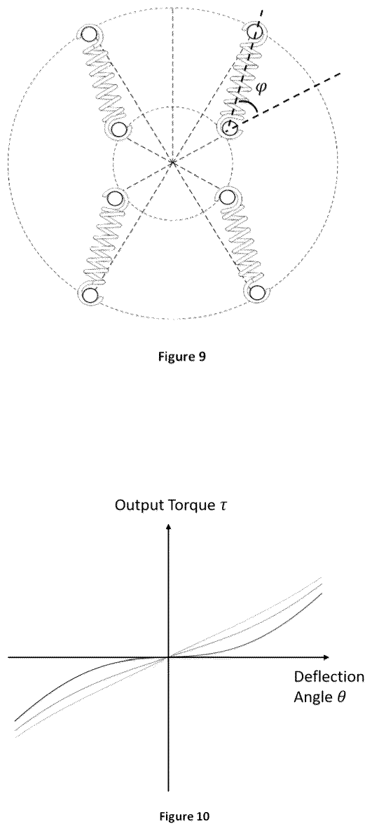

The configurations of the reconfigurable RSEE 3 can be set to a variety of nonlinear arrangements, such as those shown in FIGS. 5, 7 and 9. With reference to FIGS. 5 and 6, the tension springs 110 extend radially outwardly from positions 112 two positions 114. The tension springs 110 are equidistantly spaced around an axis of rotation 138. Despite the equidistantly spacing, as shown in FIG. 6, the relation between the output torque τ and the deflection angle θ is nonlinear. The output torque increases, by an increasing amount, the greater the magnitude of the deflection angle θ. The nonlinear relation can be adjusted by changing the pretension length Δl of one or more of the tension springs 110. With reference to FIG. 7, another nonlinear relationship can be obtained by attaching a first end of more than one spring to a position 112, and second ends of those springs to respectively different positions 114. A similar effect can be achieved by connecting multiple springs to a position 114, with opposite end is connected to respectively different positions 112, or a combination of both attachment schemes. As shown in FIG. 8, the relation between the output torque T and deflection angle θ is again non-linear. In this embodiment, the nonlinear relation can be adjusted by changing the offset angle (i.e. offsetting the angle) φ of the tension springs 110. The offset angle φ is an angle between the trajectory X of the spring from position 112 two corresponding position 114, relative to a radial line Y. For any to springs connected to a single position 112, 114, the offset angles may be the same, as shown in FIG. 7, or may be different. While the profile from deflection angle zero in the positive direction, as shown in FIG. 8, is equal and opposite to the from deflection angle zero in the negative direction, these profiles may no longer be equal if the offset angles between any two springs connected to the same position 112, 114 are different. FIG. 9 shows an alternative arrangement in which changing the offset angle φ of the tension springs 110 changes the nonlinear relation as shown in FIG. 10.

In each of the embodiments shown in FIGS. 5 to 10, all tension springs may be adjusted to change the nonlinear relation, or a subset of the tension springs may be adjusted. Similarly, in each case, the nonlinear relation can be changed by adding or removing tension strings between the inner tension spring mounted and the outer tension spring mount.

Of the embodiments set out above, and those that will be understood with reference to those embodiments, the relation between the output torque and the deflection angle is nonlinear and the stiffness can vary from a minimum value that approaches zero to a relatively large value. The nonlinear relation is maintained in a large range of deflection angle, and the torque measurement is thereby precise.

Changes in the configuration of the reconfigurable RSEE 102 can be implemented by adjusting one or more of the pretension length Δl, the offset angle φ of the tension springs 110, and the number of springs. Thus, the nonlinear relation between the output torque and the deflection angle can be adjusted as shown in FIGS. 6, 8 and 10. The reconfigurable RSEE 102 and the rotary series elastic actuator are compatible with different conditions of usage. RSEEAns the criterion can provide a wide range of stiffness including, but not limited to, 0.095 Nm/° to 2.33 0.095 Nm/°.

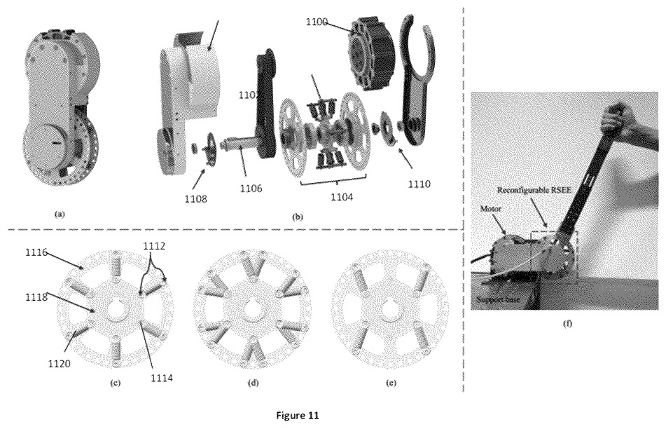

A further embodiment will now be described with reference to FIG. 11, which will then be used in testing. Notably, the size and weight of the RRSEAns can be conserved using a disk-shaped motor of 1100 with embedded gear reducer and absolute encoder to drive the RRSEAns. To further increase the output torque and also reduce the thickness of the RRSEAns, a synchronous belt 1102 was used to transmit the force between the motor 1100 and the RSEE 1104 (i.e. the shaft 1106 driven by the motor 1100 that then drives the RSEE 1104). The transmission ratio of the synchronous belt may be selected as appropriate. For example, the transmission ratio may be 2:1, which can be further increased to satisfy the requirement for a larger output torque, or reduced for lower torque. In some embodiments, after the transmission, the RRSEAns can provide a continuous torque of up to 13.2 N·m and a peak torque of more than 30 N·m. This range is adequate for most assistive robots.

The structural part may be made from any appropriate material, such as aluminum alloy which, after requirement, can result in overall weight of the RRSEAns being approximately 1 kg.

In the embodiment shown in FIG. 11, series elastic elements transfer force control to position control due to elasticity, as well as partially masking friction and reflected inertia in motors and transmission mechanisms. This allows accurate torque control and low impedance. To eliminate the influence of the transmission error, the deflection angle of the RSEE is measured using two absolute encoder is 1108, 1110. Any appropriate encoders, such as rotary encoder is, it may be used—for example, a rotary absolute encoder with a resolution of 17 bits.

In rotary SEAs, the elastic element is used as a torque sensor and a torque generator. Consequently, the performance of rotary SEAs largely depends on the characteristics of the elastic element. The present RSEE features non-linear stiffness which, compared to linear stiffness, can better meet the requirements of pHRI control. Unlike other existing rotary SEAs that employ custom torsion springs as the elastic element, a major advantage of the RRSEAns is that the desired nonlinear stiffness characteristic is generated by the novel design of the RSEE with cheap linear springs. The RSEE is designed on the basis of a coaxial rotation mechanism. In this design, two coaxial plates of the RSEE (inner and outer plate), can rotate relatively and are coupled through the tension springs. The inner plate is driven by the motor through the transmission mechanism and the outer plate is linked to the outer load. As a consequence, the compliance from the tension springs is intentionally introduced in series between the input side and the output side of the RSEE.

As shown in FIG. 11 (image (c)), a number of hitching points 1112, 1114 are placed evenly on the two plates, 1116, 1118. The tension springs 1120 are hitched between the hitching points of the two plates 1116, 1118 to couple the rotation from the input side to the output side. The stiffness of the coupling is determined by the spring stiffness, the number of springs, the pre-tension length of the spring and the offset angle in the initial position. With this design, variable stiffness values and various stiffness profiles can be obtained by choosing different configuration of the RSEE, which significantly improves the adaptability of the RRSEAns to different applications in assistive robots. Three typical configurations are shown in FIG. 11 (images (c), (d) and (e)), corresponding to FIGS. 5, 7 and 9.

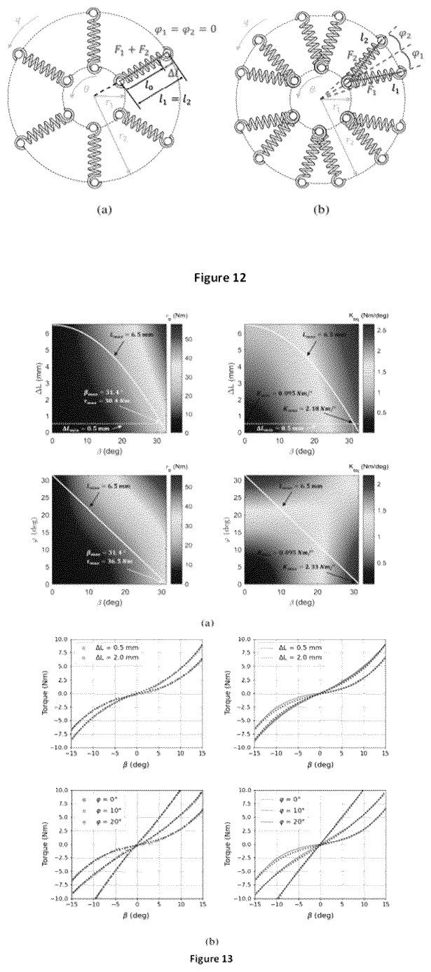

For the kinematic design, we consider two basic principles of stiffness adjustment: tuning the spring pre-tension length and tuning the offset angle in the initial position, which is described schematically in FIG. 12. A third mechanism for adjustment exists in adding or removing tension springs. The geometrical parameters and spring tension force illustrated in 12 are denoted as
l₀, ΔL being the spring rest length and the spring pre-tension length, respectively;
r₁, r₂ being the radius of the hitching points of the inner and outer plates, respectively. Specifically, r₁ is fixed, and r₂ is determined by the spring pre-tension length ΔL and can be calculated using the equation (1)

$${r}_{2} = {r}_{1} + {l}_{0} + Δ L \qquad ( 1 )$$

θ,q denote the angle of rotation of the inner and outer plates, respectively;
φ₁, φ₂ denote the offset angle is in the initial position, which are in some embodiments opposite (φ₁=−φ₂—FIG. 11, image (d)) and in other embodiments identical (φ₁=φ₂—FIG. 11, image (e));
l₁ and l₂ denote detention length of the two springs in each pair at any angle of deflection and can be calculated using equation (2)

$$\{ \begin{matrix}{l}_{1} = \sqrt{{r}_{1}^{2} + {r}_{2}^{2} - 2 {r}_{1} {r}_{2} cos ( θ - q + {φ}_{1} )} \\ {l}_{2} = \sqrt{{r}_{1}^{2} + {r}_{2}^{2} - 2 {r}_{1} {r}_{2} cos ( θ - q + {φ}_{2} )}\end{matrix} \qquad ( 2 )$$

Fᵢ(i=1,2) represented the tension force of the two springs in each pair and can be calculated according to Hooke's law per equation (3)

$${F}_{i} = {k}_{s} ( {l}_{i} - {l}_{0} )$$

With the measurement of θ and q the output torque of the RRSEAns can be calculated by equation (4)

$${τ}_{e} = h ( θ - q ) = {nk}_{s} {r}_{1} {r}_{2} [ ( 1 - \frac{{l}_{0}}{{l}_{1}} ) sin ( θ - q + {φ}_{1} ) + ( 1 - \frac{{l}_{0}}{{l}_{2}} ) sin ( θ - q + {φ}_{2} ) ] \qquad ( 4 )$$

where n=4,6 corresponds to the number of spring pairs. Thus, the equivalent rotational stiffness of the RRSEAns is defined by equation (5)

$${δτ}_{e} = {K}_{eq} \cdot δβ \qquad ( 5 )$$

where β is the deflection angle of the RSEE per equation (6)

$${K}_{eq} = \frac{{δτ}_{e}}{δβ} = \frac{{δτ}_{e}}{δ ( θ - q )} \qquad ( 6 )$$

This kinematic model can represent all configurations of the RSEE. For instance, when the offset angle in the initial position is set to 0 (φ₁=φ₂=0), it characterizes the configuration shown in FIG. 11, image (c). Also, when the number of spring pairs is set to 4 and the offset angles of the two springs in each pair are set to be identical (φ₁=φ₂), it characterizes the configuration shown in FIG. 11, image (e).

The parameters and number of tension springs are determined by taking into account the restricted installation space in the compact RSEE, as well as the requirement for a maximum output torque. On the one hand, tension springs with higher stiffness lead to higher stiffness and larger output torque of the RSEE at a large deflection angle. On the other hand, the stiffness of the RSEE around the initial position remains low due to the design characteristics of the RSEE, which can satisfy the need for establishing low impedance in the transparent mode. According to the kinematic model and the geometrical parameters of the RSEE (see Table I), tension springs with a stiffness of 20 kN/m and a rest length of 28.5 mm were selected to meet the design criterion of more than 30 N·m torque at approximately 30° of deflection, and preliminary test results showed that the tension springs complied well with Hooke's law.

Based on the kinematic model and the adjusting principles of the RSEE, simulations were performed to reveal the performance limits and characteristics of the RRSEAns. The geometrical parameters of the RSEE and the properties of the selected spring are given in Table I. It is worth noting that in order to overcome the initial tension of the selected spring and avoid the completely relaxed situation of the RSEE (K_{eq}=0—i.e. no tension in the springs. In some embodiments a subset of the springs may be permitted to have zero tension) that may cause some troubles for the use and control of the RRSEAns, the minimum pre-tension length was set to 0.5 mm for all configurations of the RSEE (including configurations with a pre-tension length and configurations with an offset angle). The following specifications were taken into account in the simulations:
Stiffness range K_{eq} ∈[Kₘᵢₙ, Kₘₐₓ]
Maximum allowable output torque τₘₐₓ
maximum deflection angle βₘₐₓ

TABLE I
parameters of the prototype and controller

| Parameter | Value | Unit |
|---|---|---|
| Size (length × width × height) | 194.5 × 103 × 53.5 | mm |
| Weight | 1.03 | kg |
| Number of spring (n) | up to 6 | pair |
| Spring stiffness (kₛ) | 20 | kN/m |
| Spring rest length (l₀) | 28.5 | mm |
| Radius of inner plate (r₁) | 24.5 | mm |
| Inertia of structural elements (Jₛ) | 2.3286 × 10⁻⁵ | kg · m² |
| Inertia of the motor (Jₘ) | 3.06 × 10⁻⁴ | kg · m² |
| Damping of the motor (bₘ) | 0 | N · ms/rad |
| Torque constant (kₘ) | 0.44 | N · m/A |
| Torque resolution | 0.0064 | N · m/deg |
| Kₚₜ | 1.5 | — |
| Kᵢₜ | 100 | — |
| Kₚᵥ | 0.6 | — |
| Kᵢᵥ | 5 | — |

FIG. 13, image (a), shows the simulation results of the effects of the two adjustable variables on the output torque and stiffness of the RRSEAns. In the figures, the dashed lines and solid lines represent the minimum pre-tension length and the maximum tension length that the selected spring can support, respectively, which determines the working space of the RRSEAns with any RSEE configuration. For the configuration with a spring pre-tension length, the maximum output torque was 30.4 N·m while the maximum deflection angle, 31.4°, was reached. The stiffness varied from 0.095 N·m/° to 2.18 N·m/°. For the configuration with an offset angle, the output torque reached a maximum, 36.5 N·m, with the maximum deflection angle of 31.4°. The stiffness can varied from 0.095 N·m/° to 2.33 N·m/°. Based on the simulations, the performance bounds and characteristics were clearly shown. Lastly, and as can be seen in the figures, the performance varied with respect to the RSEE configuration.

In order to validate the accuracy of the kinematic model, a quasi-static test was performed on the bench test system to compare the experimental torque-deflection characteristics of the RSEE with the theoretical results of equation (4). During the test, a torque sensor was connected to the RSEE output plate to measure the actual output torque, while the RSEE deflection angle was measured by two absolute encoders. In order to evaluate the torque-deflection characteristics of the RSEE for different configurations, four separate measurements were performed with a pre-tension length of 0.5 mm and 2.0 mm and an offset angle of 10° and 20°, as shown in FIG. 13, image (b). The dots, black dashed lines and solid lines represent the experimental results, the fitting curves and the theoretical results, respectively. The comparison between the experimental and theoretical results found a root-mean-square (RMS) error of 0.28, 0.21, 0.24, 0.22 N·m for the four configurations, respectively, which is less than 3.6%, 2.2%, 2.6%, 2.1% of the peak applied load. The close correlation between the fitting curves of the experimental data and the theoretical predictions shows that the kinematic model is accurate.

In FIG. 13, image (a) shows simulation results of the effects of the two adjustable variables on the output torque and stiffness of the RRSEAns. The white solid lines represent the maximum tension that the selected spring can support, indicating the working space of the RRSEAns. Top: Output torque τₑ v.s. pre-tension length ΔL and deflection angle β; stiffness K_{eq} V.S. pre-tension length ΔL and deflection angle β. Bottom: Output torque τₑ V.S. offset angle φ and deflection angle β; stiffness K_{eq} V.S. offset angle φ and deflection angle β. Image (b) is model validation by the experimental results, where the dots, black dashed lines and solid lines denote the experimental results, fitting curves and simulation results, respectively. The figures on the left show the experimental results and those on the right show the comparison of the fitting curves and the simulation results. Top: The configuration with variable pre-tension length ΔL. Bottom: The configuration with variable offset angle φ.

FIG. 13 shows that the stiffness performance of the RRSEAns can be significantly adjusted by changing the RSEE configuration. For configuration 1 (FIG. 11, image (c)), with the increase of the pretension length, the nonlinearity becomes weaker and the output torque and stiffness at the same deflection angle are increased. Note that the stiffness profile is still non-linear even with a large pre-tension length. For configuration 2 (FIG. 11, image (d)), the RSEE with an offset angle is able to vary its stiffness performance in a wider range compared to configuration 1. Hardening, linear and softening modes can be achieved as the offset angle gradually increases, in which the hardening mode is desirable for improving the performance of pHRI and the linear mode can be achieved with an offset angle of approximately 20°.

Apart from the pre-tension length and the offset angle, the number of springs also has significant influence on the performance of the RSEE. The output torque and stiffness at the same deflection angle are proportional to the number of springs. Therefore, a variety of stiffness and output torque ranges can be achieved by choosing different number of springs. For instance, according to the kinematic model, the output torque and stiffness at the same deflection angle of the configuration 2 is 1.5 times compared to that of the configuration 3 (FIG. 11, mimage (e)) with the same offset angle.

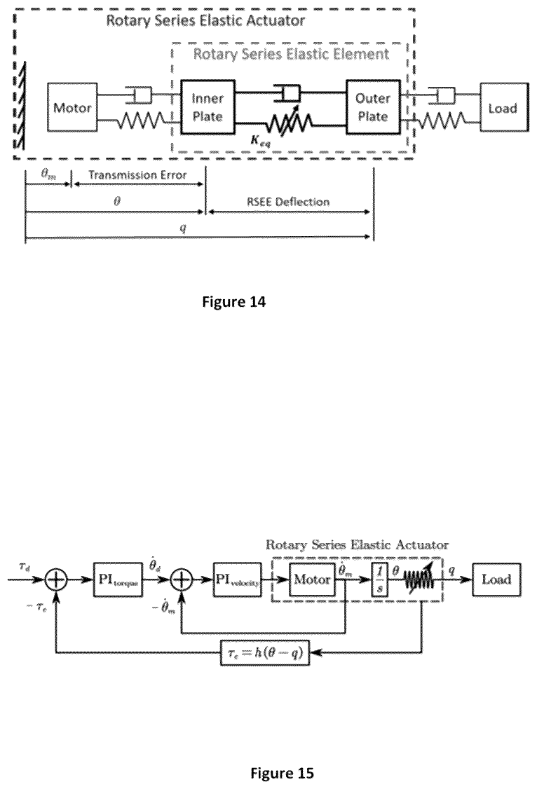

Next, motor control is considered to govern torque control. The equivalent dynamics from the motor to the output of the RRSEAns can be described as shown in FIG. 14, where the nonlinear stiffness is denoted as K_{eq} in equation (6). The dynamic model of the RRSEAns from the motor current command to the output torque can be formulated as

$$\{ \begin{matrix}{τ}_{m} + {J}_{m} {\ddot{θ}}_{m} + {b}_{m} {\dot{θ}}_{m} = {k}_{m} {i}_{m} \\ {τ}_{e} + {J}_{s} \ddot{θ} + f ( θ , \dot{θ} ) = 2 {τ}_{m} \\ {θ}_{m} = 2 θ\end{matrix} \qquad ( 7 )$$

where τₘ is the output torque of the motor, Jₘ, bₘ, kₘ are the inertia coefficient, the damping coefficient and the torque constant of the motor, respectively, iₘ is the motor current, Jₛ is the inertia of the reduction gears and the rotating components, and f (θ,θ) is the friction term. By cancelling τₘ and θₘ, we obtain the dynamics of the current command to the output torque of the RRSEAns as

$${τ}_{e} + ( {J}_{s} + 4 {J}_{m} ) \ddot{θ} + 4 {b}_{m} \dot{θ} + f ( θ , \dot{θ} ) = 2 {k}_{m} {i}_{m} \qquad ( 8 )$$

where τₑ is formulated as equation (4) according to which, and to equation (8), the nonlinearity of the torque dynamics come mainly from the non-linear stiffness.

According to some embodiments, the SBA includes a controller for controlling actuation of the motor. The controller may be a proportional-integral (PI) controller design such as that shown in FIG. 15. The PI controller may be a cascade PI controller. The torque control term PI_{torque} is the outer-loop controller and generates the command from the inner-loop controller PI_{velocity}, according to the torque tracking error. PI_{velocity} should perform fast velocity tracking according to the feedback velocity om and the desired velocity \dot{θ}_{d}.

The outer-loop controller is designed as

$${\dot{θ}}_{d} = ( {K}_{pt} + {K}_{it} \frac{1}{s} ) ( {τ}_{d} - {τ}_{e} ) \qquad ( 9 )$$

where s is the Laplace operator.

The PI velocity-loop controller of the motor acts as the inner loop, which has a large bandwidth. The velocity controller is designed as

$$2 {k}_{m} {i}_{m} = ( {K}_{pv} + {K}_{iv} \frac{1}{s} ) ( {\dot{θ}}_{d} - \dot{θ} ) \qquad ( 10 )$$

To obtain the velocity value \dot{θ}, a low-pass filter-type differentiator is adopted and designed as

$$\dot{θ} = \frac{{ω}_{c} s}{s + {ω}_{c}} θ \qquad ( 11 )$$

where ω_{c} is the cut-off frequency.

To verify the effectiveness and robustness of the cas-cade PI controller, a simulation was performed with MAT-LAB/SimuLink software. The simulation result demonstrated that with proper adjustment of the control parameters (Kₚᵥ, Kᵢᵥ, Kₚₜ, Kᵢₜ), accurate force tracking can be achieved. Moreover, since the inner-loop bandwidth is much larger than the outer-loop bandwidth, the cascade PI controller can achieve good robustness to disturbance.

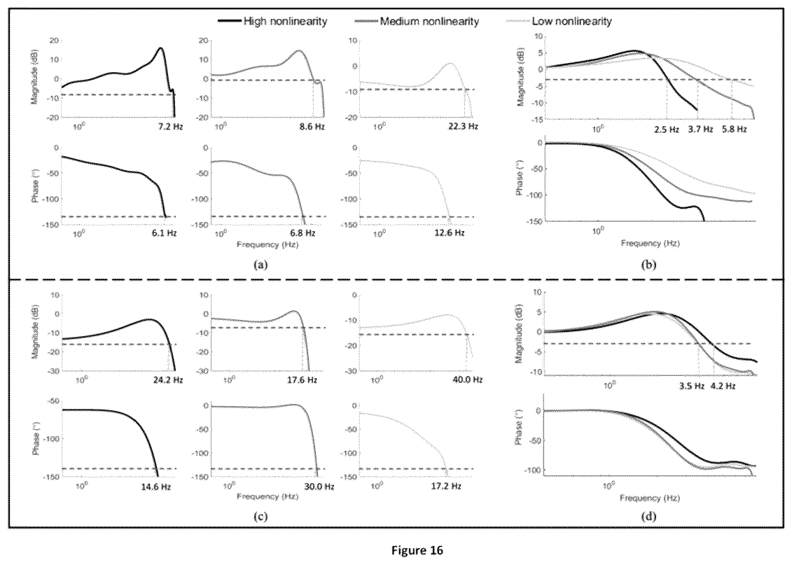

In open-loop frequency response testing higher stiffness correlates to higher bandwidth. With reference to FIG. 16, image (a), higher nonlinearity resulted in lower bandwidth as high nonlinearity corresponds to relatively low stiffness at the same deflection angle as illustrated in FIG. 13. Higher output torque operation of the RRSEAns, shown in FIG. 16 image (c), results in larger bandwidth due to higher stiffness. Comparatively, the closed-loop bandwidths shown in FIG. 16, images (b) and (d), are partially decreased. In either case, effective assistance for typical human movements is within the operating capacity of the device.

During torque tracking and step response testing, in the face of a sinusoidal trajectory and step response, the transient process is fast and satisfactory. The torque control results demonstrated that with a well-tuned cascade PI controller, the RRSEAns can perform effective and accurate torque tracking with different configurations.

During Impact load testing (e.g. accident simulation) abrupt changes in the output torque of the RRSEAns were quickly recovered back to the desired value in a short time interval (around 0.25 seconds) without chattering or a tendency towards instability.

pHRI performance was also tested for two configurations (one with low nonlinearity and the other with high nonlinearity) under three conditions: passive mode, transparent (human-in-charge) mode, and assistive (robot-in-charge) mode. In passive mode, the RRSEAns is not powered. In this mode, the reflective torque of the configuration with high nonlinearity is lower than that of the configuration with low nonlinearity, due to the lower stiffness around the initial position. This means the configuration with high nonlinearity has a lower mechanical impedance. In addition, the low reflective torques of both configurations demonstrate the high back-drivability of the RRSEAns. In transparent mode, the desired torque is set to 0 to achieve zero impedance control and minimal human interaction force. Both configurations showed low interaction torque which demonstrates high compliance of the RRSEAns in the transparent mode. The RRSEAns with high nonlinearity was found to be able to perform smoother and more comfortable transparent movement due to the lower stiffness around the initial position, which also verifies the advantages of non-linear stiffness in the pHRI. Lastly, in assistive mode the fundamental function of the actuators is activated, namely to facilitate robotic assistance. Under this test, the torque errors of both configurations were very small and the configuration with high linearity achieved accurate torque tracking with a lower deflection angle error.

Adjustable stiffness profiles are an important feature of the present RRSEAns. Adjustment can be achieved by changing the configuration of the RSEE. Task-specialized optimization can be achieved based on the adjustable stiffness profiles, and different stiffness profiles are suitable for different applications. For example, configurations with high nonlinearity may be more suitable for robots designed for upper limb rehabilitation or other assistive tasks that requires low impedance and accurate control of the interaction force. In the case of lower limb exoskeletons intended to correct abnormal gait configurations with medium or low nonlinearity may be a better option, leading to less position error, larger torque output and bandwidth.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A reconfigurable rotary series elastic element (RSEE) comprising:
an inner tension spring mount;
an outer tension spring mount; and
a plurality of tension springs connected between the inner tension spring mount and outer tension spring mount,
wherein a position at which each spring connects to one or both of the inner tension spring mount and outer tension spring mount:
can be changed to adjust a relationship between an output torque and deflection angle of the RSEE; and
is configured such that, during relative rotation of the inner tension spring mount and outer tension spring mount, an amount of tension in at least one said tension spring differs from an amount of tension in at least one other said tension spring.

2. A RSEE according to claim 1, wherein the inner tension spring mount is an inner plate, and wherein the outer tension spring mount comprises two outer plates, the inner plate being disposed between the outer plates.

3. A RSEE according to claim 1, wherein the outer tension spring mount comprises a plurality of spaced hitching holes defining locations at which the tension springs can be selected to connect to the outer tension spring mount.

4. A RSEE according to claim 1, wherein each tension spring connects to the outer tension spring mount by a connecting shaft.

5. A RSEE according to claim 4, wherein each tension spring defines an angle between the inner tension spring mount and outer tension spring mount, and wherein the relationship can be adjusted by offsetting the angle of one or more of the tension springs.

6. A RSEE according to claim 4, wherein the relationship can be adjusted by changing a pretension length of one or more of the tension springs.

7. A RSEE according to claim 1, wherein the relationship can be adjusted by changing adding or removing tension springs between the inner tension spring mount and outer tension spring mount.

8. A RSEE according to claim 2, further comprising two bearings disposed on opposite sides of the inner plate, between the inner plate and outer plates.

9. A series elastic actuator (SEA) comprising:
a RSEE according to claim 1; and
a driving assembly for driving one of the inner tension spring mount and outer tension spring mount.

10. A SEA according to claim 9, wherein the driving assembly drives the inner tension spring mount.

11. A SEA according to claim 9, further comprising a housing for housing the RSEE.

12. A SEA according to claim 9, further comprising a first angle measurer for measuring changes in an angle of the inner tension spring mount, and a second angle measurer for measuring changes in an angle of the outer tension spring mount.

13. The SEA according to claim 12, wherein the driving assembly comprises a motor for providing driving force, an embedded gear reducer, an output shaft connected to the inner tension spring mount and the first angle measurer.

14. The SEA according to claim 13, further comprising a shaft sleeve to fix a position of the output shaft along an axis of rotation of the inner tension spring mount.

15. The SEA of claim 12, wherein each angle measurer is an encoder.

16. The SEA of claim 15, wherein each encoder is a rotary encoder.
